(19) United States
(12) Patent Application Publication
(10) Pub. No.: US 2026/0102970 A1
(43) Pub. Date: Apr. 16, 2026

(54) MATERIAL EXTRUSION MECHANISM AND MOLDING MACHINE

(71) Applicant: SEIKO EPSON CORPORATION, Tokyo (JP)

(72) Inventor: Riona TODA, SHIOJIRI-SHI (JP)

(21) Appl. No.: 19/357,307

(22) Filed: Oct. 14, 2025

(30) Foreign Application Priority Data
Oct. 16, 2024 (JP) 2024-180623

(51) Int. Cl. B29C 64/209; B29C 48/02; B29C 48/52; B29C 48/80; B29C 64/321; B33Y 30/00; B33Y 40/00; B33Y 40/20

(52) U.S. Cl. CPC B29C 64/209; B29C 48/02; B29C 48/52; B29C 48/832; B29C 48/834; B29C 64/321; B33Y 30/00; B33Y 40/00; B33Y 40/20

(57) ABSTRACT

A material extrusion mechanism includes a cylinder including a supply port to which a material is supplied, a screw including a spiral flight section that rotates on a rotation axis extending in a vertical direction, a first cooling section surrounding a part of the screw, a heating section surrounding a part of the screw below the first cooling section, and at least one nozzle configured to discharge the plasticized material. At least a part of the supply port overlaps the first cooling section in a horizontal direction, the screw includes a first portion where an outer diameter of the flight section is a first diameter and a second portion wherein the outer diameter of the flight section is a smaller second diameter, the first portion overlaps the heating section in the horizontal direction, and the second portion overlaps the first cooling section in the horizontal direction.

The present application is based on, and claims priority from JP Application Serial Number 2024-180623, filed Oct. 16, 2024, the disclosure of which is hereby incorporated by reference herein in its entirety.

### BACKGROUND

### 1. Technical Field

The present disclosure relates to a material extrusion mechanism and a molding machine.

### 2. Related Art

JP-A-2012-40685 discloses a technique of reducing pinching of resin pellets by cutting out the outer peripheral portion of a screw flight of a screw used in a material supply device that supplies the resin pellets to an injection molding machine.

JP-A-2012-40685 is an example of the related art.

In JP-A-2012-40685, the reduction of the pinching of resin pellets in the material supply device is studied. However, in a material extrusion mechanism that plasticizes a material by a screw rotating centering on a rotation axis extending in the vertical direction, reduction of pinching of resin pellets is not studied.

### SUMMARY

According to a first aspect of the present disclosure, a material extrusion mechanism is provided. The material extrusion mechanism includes: a cylinder including a supply port to which a material is supplied, the cylinder being provided in a vertical direction; a screw including a spiral flight section and configured to rotate centering on a rotation axis extending in the vertical direction on an inside of the cylinder; a first cooling section provided to surround a part of the screw; a heating section provided to surround a part of the screw below the first cooling section; and at least one nozzle configured to discharge the material plasticized on the inside of the cylinder, wherein at least a part of the supply port overlaps the first cooling section in a horizontal direction, the screw includes a first portion in which an outer diameter of the flight section is a first diameter and a second portion in which the outer diameter of the flight section is a second diameter smaller than the first diameter, the first portion overlaps the heating section in the horizontal direction, and the second portion overlaps the first cooling section in the horizontal direction.

According to a second aspect of the present disclosure, a molding machine is provided. The molding machine includes: at least one of the material extrusion mechanisms in the first aspect; a material stacking section on which the material discharged from the nozzle is stacked; and a moving mechanism configured to change relative positions of the material extrusion mechanism and the material stacking section, and the molding machine molds a molded product by stacking the material discharged from the nozzle.

### BRIEF DESCRIPTION OF THE DRAWINGS

FIG. 1 is a diagram illustrating a schematic configuration of a molding machine.

FIG. 2 is a perspective view illustrating a schematic configuration of a screw.

FIG. 3 is a diagram illustrating a configuration of a first cooling flow path.

FIG. 4 is a diagram illustrating the configuration of a second cooling flow path.

FIG. 5 is a diagram illustrating a connecting section between a section to be cooled of a cylinder and a case of a screw drive section.

FIG. 6 is an enlarged view of the vicinity of a supply port in FIG. 1.

FIG. 7 is a perspective view of a plasticizing section in the vicinity of the supply port taken along a cross section including a rotation axis.

FIG. 8 is a perspective view of the screw in the vicinity of a boundary between a first portion and a second portion.

FIG. 9 is a diagram illustrating the shape of a flight section in a cross section of the screw including the rotation axis.

FIG. 10 is a diagram illustrating a schematic configuration of a molding machine in a second embodiment.

FIG. 11 is a diagram illustrating a schematic configuration of a machining section.

FIG. 12 is a diagram illustrating a schematic configuration of a molding machine in a third embodiment.

FIG. 13 is a diagram illustrating the shape of a flight section in a cross section of a screw including a rotation axis in another embodiment.

FIG. 14 is a diagram illustrating the shape of a flight section in a cross section of a screw including a rotation axis in another embodiment.

### DESCRIPTION OF EMBODIMENTS

### A. First Embodiment

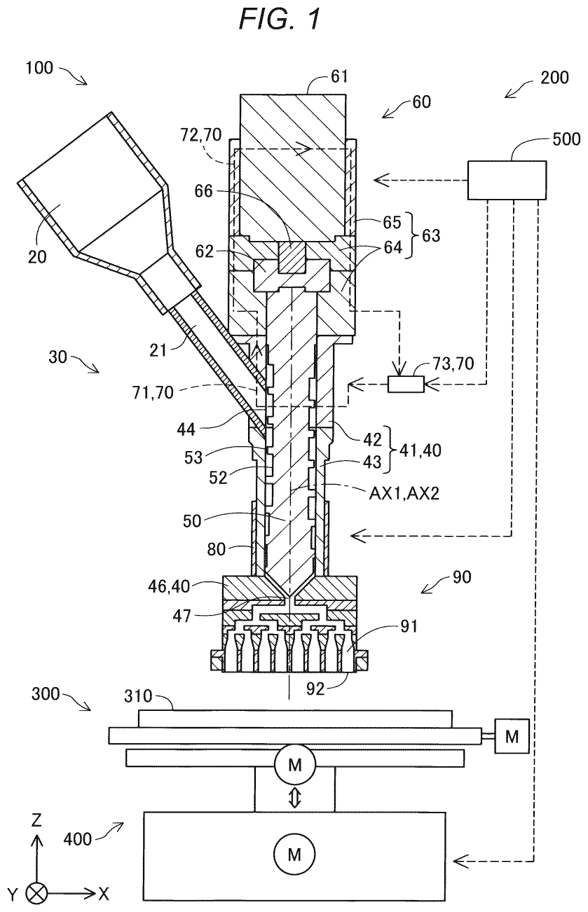

FIG. 1 is a diagram illustrating a schematic configuration of a molding machine 100. In FIG. 1, arrows indicating X, Y, and Z directions perpendicular to one another are illustrated. The X direction and the Y direction are directions parallel to the horizontal plane. The Z direction is a direction parallel to the vertical direction. The X, Y, and Z directions in FIG. 1 and the X, Y, and Z directions in the other figures indicate the same directions. When a direction is specified, positive or negative signs are used together for direction notation with a positive direction, which is a direction indicated by an arrow, represented as “+” and a negative direction, which is a direction opposite to the direction indicated by the arrow, represented as “−”. The +Z direction is also referred to as “upward” and the −Z direction is also referred to as “downward”.

The molding machine 100 includes a material extrusion mechanism 200, a material stacking section 300, a moving mechanism 400, and a control section 500. The molding machine 100 molds a molded product by stacking a material discharged from the material extrusion mechanism 200 on the material stacking section 300. Under the control of the control section 500, while discharging a plasticized material from a nozzle hole 92 of a discharge section 90 provided in the material extrusion mechanism 200 toward a molding surface 310 of the material stacking section 300, the molding machine 100 drives the moving mechanism 400 to change relative positions of the nozzle hole 92 and the molding surface 310 to thereby mold a molded product, in which layers of a plasticized material are stacked, on the molding surface 310. The material stacking section 300 is also called stage.

As explained above, the moving mechanism 400 changes the relative positions of the nozzle hole 92 and the molding surface 310. In the present embodiment, the moving mechanism 400 supports the material stacking section 300 and changes the relative positions of the nozzle hole 92 and the molding surface 310 by moving the material stacking section 300 with respect to the material extrusion mechanism 200. The moving mechanism 400 in the present embodiment includes a three-axis positioner that moves the material stacking section 300 in three axial directions of the X, Y, and Z directions with driving forces of three motors. The motors are driven under the control of the control section 500. The moving mechanism 400 may not be configured to move the material stacking section 300 but may be configured to change the relative positions of the nozzle hole 92 and the molding surface 310 by moving the material extrusion mechanism 200 without moving the material stacking section 300. The moving mechanism 400 may be configured to change the relative positions of the nozzle hole 92 and the molding surface 310 by moving both the material stacking section 300 and the material extrusion mechanism 200.

The control section 500 includes a computer including one or more processors, a main storage device, and an input and output interface for inputting and outputting signals from and to the outside. In the present embodiment, the control section 500 controls the operations of the material extrusion mechanism 200 and the moving mechanism 400 by the processor executing a program or an instruction read on the main storage device and executes molding processing for molding a molded product. The operation includes changing three-dimensional relative positions of the material extrusion mechanism 200 and the material stacking section 300. The control section 500 may include a combination of a plurality of circuits rather than the computer.

The material extrusion mechanism 200 discharges a plasticized material obtained by plasticizing a material in a solid state onto the material stacking section 300 under the control of the control section 500. The material extrusion mechanism 200 includes a material supply section 20, which is a supply source of the material, a plasticizing section 30 that converts the material into a plasticized material, and a discharge section 90 that discharges the plasticized material supplied from the plasticizing section 30 toward the material stacking section 300. “Plasticize” is a concept including melting and means changing a solid to a state having fluidity. Specifically, in the case of a material in which glass transition occurs, “plasticize” means setting the temperature of the material to temperature equal to or higher than the glass transition point. In the case of a material in which glass transition does not occur, “plasticize” means setting the temperature of the material to temperature equal to or higher than the melting point.

A pellet-like material is stored in the material supply section 20. The material supply section 20 includes, for example, a hopper. As the material, thermoplastic resins such as polypropylene resin (PP), polyethylene resin (PE), polyacetal resin (POM), or polyphenylene sulfide resin (PPS) is used. A communication path 21, which connects the material supply section 20 and the plasticizing section 30, is provided below the material supply section 20. The communication path 21 is coupled to a cylinder 40 explained below from the obliquely upward direction. The communication path 21 has a cylindrical shape. The material supply section 20 supplies the material to the plasticizing section 30 via the communication path 21.

The plasticizing section 30 plasticizes at least a part of the material supplied from the material supply section 20, generates a paste-like plasticized material having fluidity, and guides the plasticized material to the discharge section 90. The plasticizing section 30 includes a cylinder 40, a screw 50, a screw drive section 60, a cooling section 70, and a heating section 80. The screw drive section 60, the cylinder 40, and the discharge section 90 are disposed in this order from the upper side to the lower side.

The cylinder 40 includes a main body section 41 and a nozzle fixing section 46 provided at the lower end of the main body section 41. The main body section 41 has a cylindrical shape centering on a central axis AX1. The main body section 41 is disposed such that the central axis AX1 extends in the vertical direction. The main body section 41 includes a section to be cooled 42 and a section to be heated 43 located below the section to be cooled 42. A supply port 44 to which a material is supplied from the material supply section 20 via the communication path 21 is provided at a connecting section of the section to be cooled 42 and the section to be heated 43. Specifically, the supply port 44 is provided across the lower end of the section to be cooled 42 and the upper end of the section to be heated 43. The upper end of the section to be cooled 42 is formed in a flange shape. The screw drive section 60 is fixed to the upper end of the section to be cooled 42. The nozzle fixing section 46 is fixed to a lower end of the section to be heated 43. The nozzle fixing section 46 has a disk shape. A through hole 47 penetrating the nozzle fixing section 46 in the Z direction is provided at the center of the nozzle fixing section 46. The discharge section 90 is coupled to the lower end of the nozzle fixing section 46.

In the present embodiment, the section to be cooled 42, the section to be heated 43, and the nozzle fixing section 46 are respectively formed of stainless steel. In the present embodiment, the section to be cooled 42 and the section to be heated 43 are integrally formed. For example, the section to be cooled 42 and the section to be heated 43 can be integrally formed by bonding the section to be cooled 42 and the section to be heated 43 using a metal bonding technique such as diffusion bonding or hot isostatic press (HIP) bonding. The section to be cooled 42 and the section to be heated 43 may be integrally formed using a three-dimensional shaping technique. At least one of the sections to be cooled 42 and the section to be heated 43 may be formed of, rather than the stainless steel, for example, another metal material such as a titanium alloy, a resin material, or a ceramic material. The section to be cooled 42 and the section to be heated 43 may be formed of different kinds of metal material.

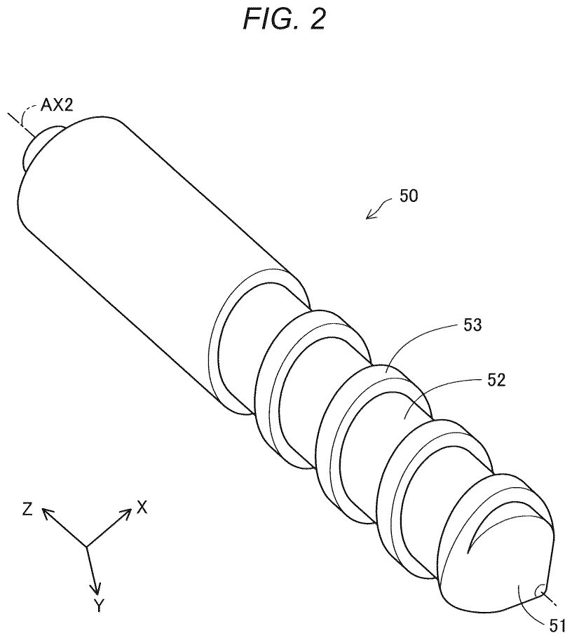

FIG. 2 is a perspective view illustrating a schematic configuration of the screw 50. Hereinafter, a configuration of the screw 50 is explained with reference to FIGS. 1 and 2. The screw 50 is housed on the inside of the cylinder 40. More specifically, the screw 50 is housed in a space surrounded by the main body section 41 of the cylinder 40, the nozzle fixing section 46 of the cylinder 40, and a case 63 of the screw drive section 60 explained below. The screw 50 has an axial shape centering on a rotation axis AX2. The screw 50 is disposed such that the rotation axis AX2 extends along the central axis AX1 of the main body section 41 of the cylinder 40. An upper end of the screw 50 is coupled to a screw drive section 60. A distal end portion 51 of the screw 50 is located in the vicinity of the through hole 47. A spiral groove section 52 centering on the rotation axis AX2 is provided in a side surface portion of the screw 50. The groove section 52 is provided continuously from a portion of the screw 50 located above the supply port 44 to the distal end portion 51 of the screw 50. A spiral flight section 53 that separates pieces of the groove section 52 from one another is provided between the pieces of the groove section 52. A value obtained by dividing the length of the screw 50 in the direction along the rotation axis AX2 by the diameter of the screw 50 is preferably approximately 5 to 10. In the present embodiment, the screw 50 is formed of stainless steel subjected to quenching. The screw 50 may be formed of, rather than the stainless steel subjected to the quenching, for example, another metal material such as a titanium alloy or may be formed of a resin material or a ceramic material. A specific configuration of the flight section 53 of the screw 50 is explained below.

The screw drive section 60 illustrated in FIG. 1 includes a drive motor 61, a speed reducer 62, and a case 63. The case 63 includes a gear case section 64 and a motor case section 65. The gear case section 64 is fixed to the upper end of the section to be cooled 42 of the cylinder 40. The gear case section 64 has a rectangular parallelepiped shape. The speed reducer 62 is housed on the inside of the gear case section 64. The motor case section 65 is fixed to the upper surface of the gear case section 64. The motor case section 65 has a cylindrical shape. The drive motor 61 is housed in a hollow portion of the motor case section 65. In the present embodiment, a servo motor is used as the drive motor 61. In the present embodiment, the speed reducer 62 includes a gear. The drive motor 61 is driven under the control of the control section 500. A rotating shaft 66 of the drive motor 61 is coupled to the upper end portion of the screw 50 via the speed reducer 62. The screw 50 rotates centering on the rotation axis AX2 on the inside of the cylinder 40 with torque applied from the drive motor 61 via the speed reducer 62. As the drive motor 61, for example, a stepping motor may be used. The speed reducer 62 may include a pulley and a belt. The screw drive section 60 may not include the speed reducer 62 and the gear case section 64. The rotating shaft 66 of the drive motor 61 may be coupled to the upper end portion of the screw 50. The drive motor 61 is sometimes simply referred to as motor. The width in the horizontal direction of the screw drive section 60 is larger than the width in the horizontal direction of a first cooling section 71 provided in the cooling section 70 explained below.

The cooling section 70 includes a first cooling section 71, a second cooling section 72, and a coolant supply section 73. The first cooling section 71 and the second cooling section 72 are flow paths in which coolant flows. Hereinafter, the first cooling section 71 is also referred to as first cooling flow path 71 and the second cooling section 72 is also referred to as second cooling flow path 72.

The first cooling flow path 71 is provided in the cylinder 40. The first cooling flow path 71 is provided on the inside of the section to be cooled 42 as a three-dimensional path passing through the vicinity of the supply port 44. At least a part of the supply port 44 overlaps the first cooling flow path 71 in the horizontal direction. The first cooling flow path 71 includes a hole including a three-dimensional path provided in the section to be cooled 42. One end of the first cooling flow path 71 is coupled to the second cooling flow path 72. The other end of the first cooling flow path 71 is coupled to the coolant supply section 73 via a pipe or the like. A detailed configuration of the first cooling flow path 71 is explained below.

The second cooling flow path 72 is provided on the inside of the case 63. In the present embodiment, the second cooling flow path 72 is provided as a three-dimensional path that passes through both of the inside of the gear case section 64 and the inside of the motor case section 65. The second cooling flow path 72 includes a hole having a three-dimensional path provided in the gear case section 64 and the motor case section 65. One end of the second cooling flow path 72 is coupled to the coolant supply section 73 via a pipe or the like. The other end of the second cooling flow path 72 is coupled to the first cooling flow path 71. A detailed configuration of the second cooling flow path 72 is explained below.

The coolant supply section 73 includes a chiller that removes the heat of the coolant having flowed in the first cooling flow path 71 and the second cooling flow path 72 while circulating the coolant to the first cooling flow path 71 and the second cooling flow path 72. In the present embodiment, the coolant supplied from the coolant supply section 73 flows in the first cooling flow path 71 and the second cooling flow path 72 in this order. The coolant supply section 73 is driven under the control of the control section 500. In the present embodiment, water is used as the coolant. As the coolant, for example, oil or air may be used rather than water. Only the first cooling flow path 71 may be coupled to the coolant supply section 73. In this case, for example, the coolant having flowed from the first cooling flow path 71 to the second cooling flow path 72 may be discharged to the outside without circulating to the coolant supply section 73.

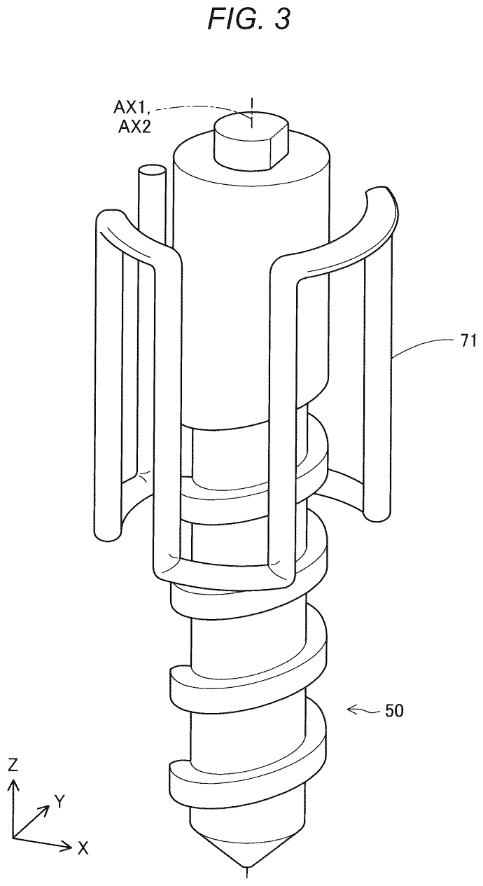

FIG. 3 is a diagram illustrating a configuration of the first cooling flow path 71 in the present embodiment. In FIG. 3, the screw 50 is illustrated together with the first cooling flow path 71. In FIG. 3, the external shape of the cylinder 40 is not illustrated and the inner wall surface of the cylinder 40 forming the first cooling flow path 71 is illustrated. The first cooling flow path 71 is provided to surround a part of the screw 50. In the present embodiment, one first cooling flow path 71 is three-dimensionally disposed in the section to be cooled 42 of the cylinder 40. The first cooling flow path 71 is three-dimensionally disposed by connecting a portion extending in the Z direction and a portion extending in the circumferential direction of a circle centering on the central axis AX1. The first cooling flow path 71 is equally disposed over the entire circumference of the section to be cooled 42. The section to be cooled 42 of the cylinder 40 is cooled by the coolant flowing in the first cooling flow path 71. The first cooling flow path 71 may branch on the inside of the section to be cooled 42. A plurality of first cooling flow paths 71 may be provided on the inside of the section to be cooled 42.

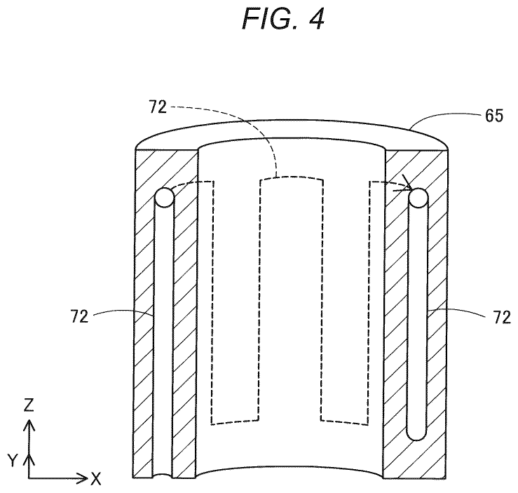

FIG. 4 is a diagram illustrating a configuration of the second cooling flow path 72 in the present embodiment. In FIG. 4, a cross section of the motor case section 65 is illustrated. In FIG. 4, a path of the second cooling flow path 72 provided on the inside of the motor case section 65 is indicated by a broken line. In the present embodiment, one second cooling flow path 72 is three-dimensionally disposed in the motor case section 65. The second cooling flow path 72 is three-dimensionally disposed by a portion extending in the Z direction and a portion extending in the circumferential direction of the cylindrical motor case section 65 being connected. The second cooling flow path 72 is equally disposed over the entire circumference of the motor case section 65. The second cooling flow path 72 may branch on the inside of the motor case section 65. A plurality of second cooling flow paths 72 may be provided on the inside of the motor case section 65.

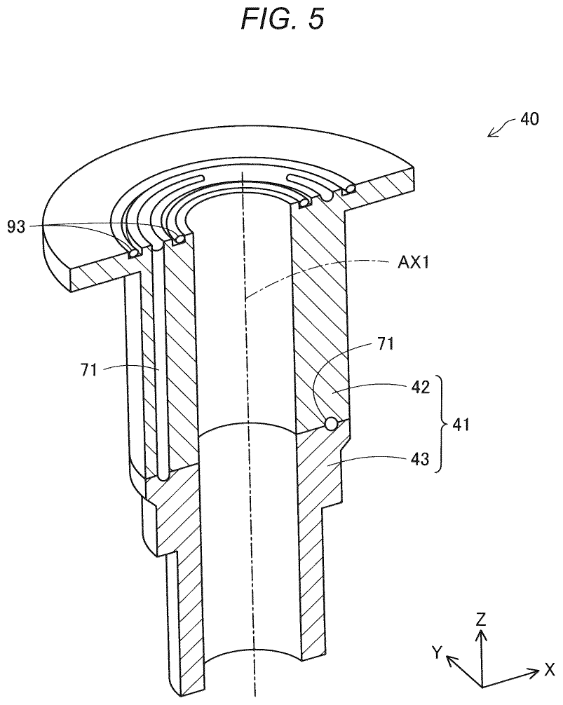

FIG. 5 is a diagram illustrating a coupling portion of the section to be cooled 42 of the cylinder 40 and the case 63 of the screw drive section 60. In FIG. 5, the case 63 is not illustrated and the cylinder 40 cut by a plane passing the central axis AX1 is illustrated. In the present embodiment, a groove communicating with the first cooling flow path 71 is provided on the upper end surface of the section to be cooled 42 of the cylinder 40. The groove provided on the upper end surface of the section to be cooled 42 extends in the circumferential direction of a circle centering on the central axis AX1. On the lower surface of the gear case section 64 of the case 63, a groove communicating with the second cooling flow path 72 is provided upside down from the groove provided on the upper end surface of the section to be cooled 42. The section to be cooled 42 and the gear case section 64 are coupled, whereby the groove provided in the section to be cooled 42 and the groove provided in the gear case section 64 are combined and the first cooling flow path 71 and the second cooling flow path 72 are coupled. Grooves in which O-rings 93 are fitted are provided on both sides of the groove provided in the section to be cooled 42. The O-rings 93 are crushed by the section to be cooled 42 and the gear case section 64 and leakage of the coolant from between the section to be cooled 42 and the gear case section 64 is suppressed.

In the present embodiment, the groove extending in the circumferential direction of the circle centering on the central axis AX1 is provided on the lower end surface of the section to be cooled 42. The groove is provided on the upper end surface of the section to be heated 43 upside down from the groove provided on the lower end surface of the section to be cooled 42. The section to be cooled 42 and the section to be heated 43 are coupled, whereby the groove provided on the lower end surface of the section to be cooled 42 and the groove provided on the upper end surface of the section to be heated 43 are combined to form a part of the first cooling flow path 71. A through hole linearly extending along the central axis AX1 is provided on the inside of the section to be cooled 42. The through hole communicates with the groove provided on the upper end surface of the section to be cooled 42 and the groove provided on the lower end surface of the section to be cooled 42. A part of the first cooling flow path 71 is formed by the through hole.

The heating section 80 illustrated in FIG. 1 is provided to surround a part of the screw 50 below the cooling section 70. Specifically, the heating section 80 is provided to surround a portion of the section to be heated 43 below a portion where the first cooling flow path 71 is formed. In other words, the first cooling flow path 71 is provided above a region of the section to be heated 43 heated by the heating section 80. The heating section 80 is an electric heater. The heating section 80 is, for example, a resistance heating type heater. In the present embodiment, the heating section 80 is provided along a portion located between the supply port 44 and the discharge section 90 on the surface of the outer circumference of the section to be heated 43. The heating section 80 may be embedded in the outer circumference of the section to be heated 43 located between the supply port 44 and the discharge section 90. The temperature of the heating section 80 is controlled by the control section 500. For example, the control section 500 may control the temperature of the heating section 80 using temperature acquired by a temperature sensor provided in the heating section 80. The heating section 80 is not limited to the electric heater, and may be a gas heating type heater or the like.

The discharge section 90 is provided on the lower surface of the nozzle fixing section 46 in the cylinder 40. In the present embodiment, the discharge section 90 includes eight nozzles 91. Nozzle holes 92 are provided at the distal end portions of the nozzles 91. The nozzle holes 92 communicate with the through hole 47 of the nozzle fixing section 46. A plasticized material flowing into internal flow paths of the nozzles 91 from the through hole 47 is discharged from the nozzle holes 92. In the present specification, discharging the plasticized material from the nozzle holes 92 of the discharge section 90 is also referred to as “extruding the plasticized material from the nozzle holes 92”. The discharge section 90 may include two or more and seven or less nozzles 91 or nine or more nozzles 91. The discharge section 90 may include one nozzle 91.

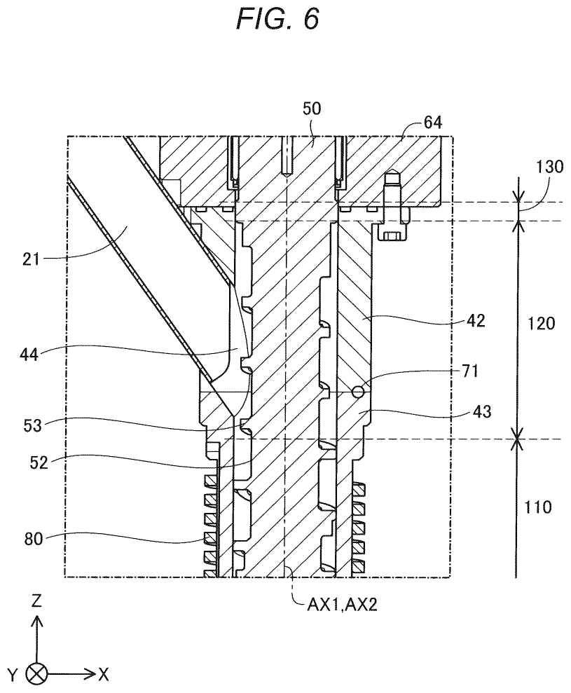

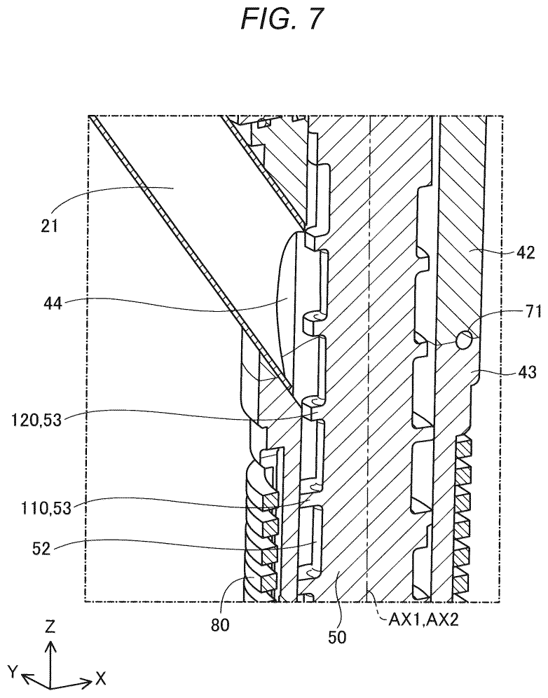

FIG. 6 is an enlarged view of the vicinity of the supply port 44 in FIG. 1. FIG. 7 is a perspective view of the plasticizing section 30 in the vicinity of the supply port 44 taken along a cross section including the rotation axis AX2. The screw 50 includes a first portion 110 in which the outer diameter of the flight section 53 is a first diameter, a second portion 120 in which the outer diameter of the flight section 53 is a second diameter smaller than the first diameter, and a third portion 130 that is located above the flight section 53 and in which the outer diameter of the screw 50 is the first diameter. The first diameter is preferably a value slightly smaller than the inner diameter of the cylinder 40. For example, the difference between the first diameter and the inner diameter of the cylinder 40 is preferably 0.5 mm or less. The second diameter is determined based on the size of a pellet-like material supplied from the material supply section 20. The difference between the first diameter and the second diameter is preferably the same degree as the diameter of the pellet-like material.

The first portion 110 is provided in a region surrounded by the section to be heated 43 of the cylinder 40 in the flight section 53. The second portion 120 is provided above the first portion 110. A boundary between the first portion 110 and the second portion 120 is located, in the vertical direction, above a region heated by the heating section 80 in the section to be heated 43 and below a region where the first cooling flow path 71 is formed in the section to be heated 43. That is, the first portion 110 overlaps the heating section 80 in the horizontal direction. The first portion 110 is continuously provided from the boundary with the second portion 120 to the distal end portion 51 of the screw 50.

The second portion 120 is provided in a part of a region surrounded by the section to be cooled 42 of the cylinder 40 and a region surrounded by the section to be heated 43 of the cylinder 40 in the flight section 53. That is, the second portion 120 overlaps the cooling section 70 in the horizontal direction. The second portion 120 is continuously provided from the boundary with the first portion 110 explained above to the upper end portion of the flight section 53.

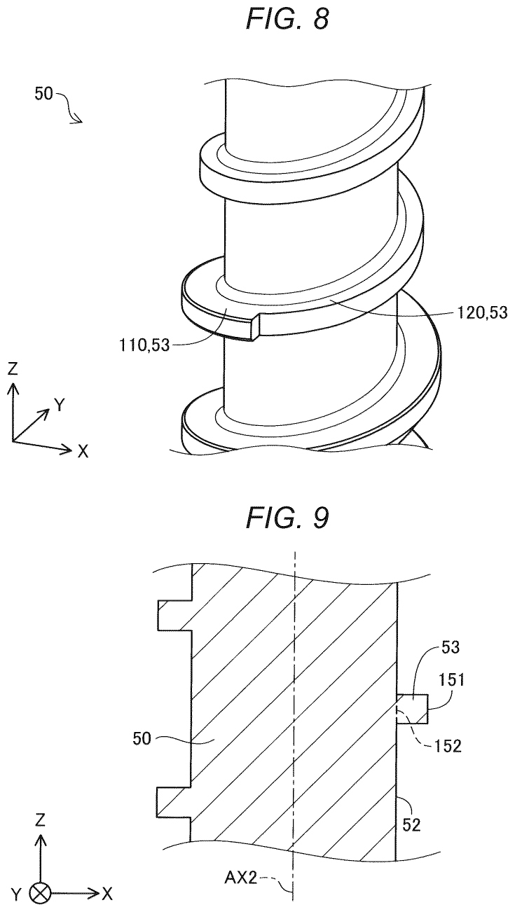

FIG. 8 is a perspective view of the screw 50 in the vicinity of the boundary between the first portion 110 and the second portion 120. The flight section 53 has a stepped shape at the boundary between the first portion 110 and the second portion 120. That is, the outer diameter of the flight section 53 changes from the first diameter to the second diameter at one position in the vertical direction. The outer diameter of the flight section 53 may smoothly change from the first diameter to the second diameter at the boundary between the first portion 110 and the second portion 120.

FIG. 9 is a diagram illustrating the shape of the flight section 53 in a cross section of the screw 50 including the rotation axis AX2. Hereinafter, the cross section of the screw 50 including the rotation axis AX2 is also referred to as first cross section. In the present embodiment, the shape of the first portion 110 and the shape of the second portion 120 in the first cross section are the same. A cross section of the flight section 53 in the first cross section has a rectangular shape having a first side 151 and a second side 152 parallel to the rotation axis AX2. Here, the second side 152 is a side located at a position having the same outer diameter as the outer diameter of the groove section 52 of the screw 50. The first side 151 is a side located at a position further away from the rotation axis AX2 than the second side 152 and located at a position where the outer diameter of the flight section 53 is the largest. The cross section of the flight section 53 in the first cross section may be a trapezoidal shape in which the length of the first side 151 is less than the length of the second side 152. The cross section of the flight section 53 in the first cross section may have a substantially trapezoidal shape in which corner portions located at both the ends of the first side 151 are rounded. The shape of the flight section 53 in the first cross section explained above may be formed only in the second portion 120.

The third portion 130 illustrated in FIG. 6 is located at the upper end portion of the screw 50. In the present embodiment, the third portion 130 is provided at height at which the boundary between the section to be cooled 42 and a gear case is located in the vertical direction. The third portion 130 may be provided from the boundary with the second portion 120, which is the flight section 53, to the upper end of the screw 50 coupled to the screw drive section 60.

According to the first embodiment explained above, the material extrusion mechanism 200 includes the cylinder 40 including the supply port 44 to which a material is supplied, the screw 50 that rotates centering on the rotation axis AX2 extending in the vertical direction on the inside of the cylinder 40, the first cooling section 71 provided to surround a part of the screw 50, and the heating section 80 provided to surround a part of the screw 50 below the first cooling section 71. At least a part of the supply port 44 overlaps the first cooling section 71 in the horizontal direction, the screw 50 includes the first portion 110 in which the outer diameter of the flight section 53 is the first diameter and the second portion 120 in which the outer diameter of the flight section 53 is the second diameter smaller than the first diameter, the first portion 110 overlaps the heating section 80 in the horizontal direction, and the second portion 120 overlaps the first cooling section 71 in the horizontal direction. For that reason, in the material extrusion mechanism 200 that plasticizes the material by the screw 50 rotating centering on the rotation axis AX2 extending in the vertical direction, it is possible to reduce the likelihood of the material supplied from the supply port 44 being pinched between the screw 50 and the cylinder 40. In the present embodiment, the screw 50 is less likely to be cooled by the first cooling section 71 compared with when the outer diameter of the flight section 53 overlapping the first cooling section 71 in the horizontal direction is the first diameter. For that reason, compared with the case explained above, it is possible to make it easy to melt a material in a space between the screw 50 and the cylinder 40. When the material extrusion mechanism 200 is a small device, since the rotational torque of the screw 50 is small, the rotation of the screw 50 easily stops when the material is pinched between the screw 50 and the cylinder 40. In the present embodiment, since the material is less easily pinched between the screw 50 and the cylinder 40, it is possible to prevent the rotation of the screw 50 from easily stopping even if the material extrusion mechanism 200 is a small device.

In the material extrusion mechanism 200 that plasticizes the material by the screw 50 rotating centering on the rotation axis AX2 extending in the vertical direction, in order to reduce the length in the vertical direction of the screw 50, it is necessary to increase a temperature gradient in the vertical direction of the screw 50. Specifically, it is necessary to prevent the material supplied from the supply port 44 from being melted in the vicinity of the supply port 44 by the heat of the heating section 80 by cooling the vicinity of the supply port 44 with the cooling section 70. This is because, when the material melts in the vicinity of the supply port 44, it is difficult to convey the material to the discharge section 90 with the rotation of the screw 50. In the present embodiment, the cylinder 40 includes the section to be cooled 42 cooled by the cooling section 70 and the section to be heated 43 located below the section to be cooled 42 and heated by the heating section 80. The cooling section 70 is the cooling flow path in which the coolant flows, and the cooling flow path is provided above the section to be cooled 42 and the region heated by the heating section 80 in the section to be heated 43. For that reason, it is possible to increase the temperature gradient in the vertical direction of the screw 50 and it is possible to reduce the likelihood of the material supplied from the supply port 44 being pinched between the screw 50 and the cylinder 40 in the material extrusion mechanism 200 in which the screw 50 is short in the vertical direction. The length in the vertical direction of the material extrusion mechanism 200 can be reduced.

Further, in the present embodiment, the material extrusion mechanism 200 further includes the screw drive section 60 provided above the screw 50 and including the motor that rotates the screw 50. The screw 50 includes the third portion 130 in which the outer diameter of the flight section 53 is the first diameter. The third portion 130 is located at the upper end portion of the screw 50. For that reason, it is possible to prevent the material supplied from the supply port 44 into the cylinder 40 from intruding into the screw drive section 60.

Further, in the present embodiment, the material extrusion mechanism 200 further includes the screw drive section 60 provided above the screw 50 and including the motor that rotates the screw 50. The width in the horizontal direction of the screw drive section 60 is larger than the width in the horizontal direction of the cooling section 70. For that reason, a motor having size enough for obtaining output necessary for the rotation of the screw 50 can be installed in the screw drive section 60.

Further, in the present embodiment, the cross section of the flight section 53 in the cross section of the screw 50 including the rotation axis AX2 has a trapezoidal shape having the first side 151 and the second side 152 parallel to the rotation axis AX2. The first side 151 is located at a position further away from the rotation axis AX2 than the second side 152. The length of the first side 151 is equal to or smaller than the length of the second side 152. For that reason, when the screw 50 rotates centering on the rotation axis AX2, it is possible to make it easy to convey the material downward.

Further, in the present embodiment, the material extrusion mechanism 200 includes two or more nozzles 91. For that reason, it is possible to improve the productivity of the molded product compared with when the material extrusion mechanism 200 includes one nozzle 91.

Further, in the present embodiment, the molding machine 100 includes the material extrusion mechanism 200 explained above, the material stacking section 300 on which the material discharged from the nozzle 91 is stacked, and the moving mechanism 400 that changes the relative positions of the material extrusion mechanism 200 and the material stacking section 300. The molding machine 100 molds the molded product by stacking the material discharged from the nozzle 91. For that reason, in the molding machine 100, it is possible to reduce the likelihood of the material supplied from the supply port 44 being pinched between the screw 50 and the cylinder 40.

### B. Second Embodiment

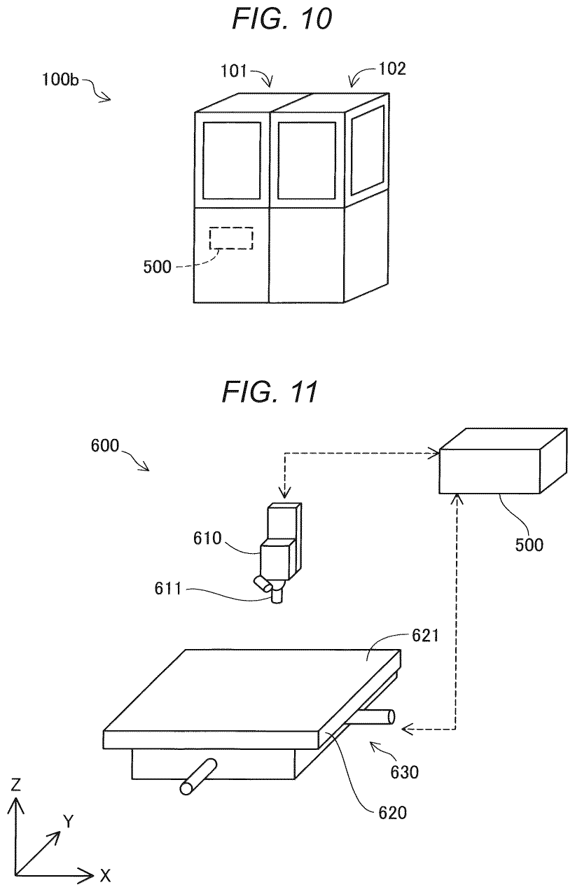

FIG. 10 is a diagram illustrating a schematic configuration of a molding machine 100b in the second embodiment. The molding machine 100b includes a molding cell 101 and a machining cell 102. The material extrusion mechanism 200, the material stacking section 300, the moving mechanism 400, and the control section 500 are housed on the inside of the molding cell 101. In the second embodiment, the material extrusion mechanism 200, the material stacking section 300, and the moving mechanism 400 are collectively referred to as molding unit as well. A machining section 600 explained below is housed on the inside of the machining cell 102. In the second embodiment, the control section 500 controls the molding unit and the machining section 600. The material extrusion mechanism 200, the material stacking section 300, the moving mechanism 400, the control section 500, and the machining section 600 may be housed in one cell.

FIG. 11 is a diagram illustrating a schematic configuration of the machining section 600. The machining section 600 includes a cutting section 610, a stage 620, and a moving mechanism 630. The machining section 600 performs machining of a molded product molded by the molding unit. Under the control of the control section 500, while rotating a cutting tool 611 attached to the cutting section 610, the machining section 600 drives the moving mechanism 630 to change relative positions of the cutting tool 611 and the stage 620 to thereby cut the molded product molded by the molding unit with the cutting tool 611. In the second embodiment, for example, a molding unit molds a molded product having a substantially rectangular parallelepiped shape and the machining section 600 cuts the molded product to form a shape of a cavity to manufacture a mold used for injection molding. The machining section 600 may perform grinding of the molded product rather than cutting of the molded product.

The stage 620 is supported by the moving mechanism 630. The stage 620 includes a cutting surface 621 facing the cutting section 610. The molded product molded by the molding unit is conveyed from the molding cell 101 to the machining cell 102 by, for example, a robot and fixed on the cutting surface 621. In the present embodiment, the cutting surface 621 is provided in parallel to the horizontal plane. Since a configuration of the moving mechanism 630 is the same as the configuration of the moving mechanism 400, explanation of the configuration is omitted. When the molding unit and the machining section 600 are housed in one cell, the molding machine 100b may not include the stage 620 and the moving mechanism 630. In this case, the cutting section 610 machines the molded product fixed on the molding surface 310 of the material stacking section 300.

The cutting section 610 is a cutting device that rotates the cutting tool 611 attached to a shaft at a head tip to cut the molded product fixed on the stage 620. As the cutting tool 611, for example, a drill, a flat end mill, or a ball end mill can be used. The cutting section 610 detects a position of the distal end of the cutting tool 611 with a general position detection sensor and transmits a detection result to the control section 500. The control section 500 controls the moving mechanism 630 using the detection result to thereby change relative positions of the cutting tool 611 and the molded product fixed on the stage 620 and cut the molded product.

According to the second embodiment explained above, the molding machine 100b includes the machining section 600 that machines the molded product molded by the molding unit. For that reason, it is possible to improve the quality of the molded product by the machining section 600 adjusting the shape of the molded product.

### C. Third Embodiment

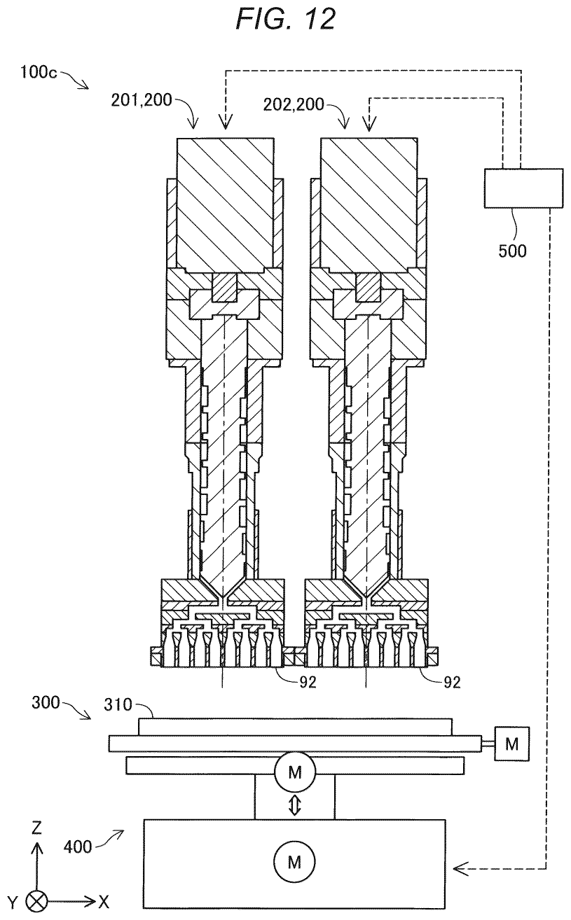

FIG. 12 is a diagram illustrating a schematic configuration of a molding machine 100c in a third embodiment. In the third embodiment, the molding machine 100c includes two material extrusion mechanisms 200. Configurations of sections of the molding machine 100c other than the material extrusion mechanisms are the same as the configurations in the first embodiment. In FIG. 12, the material supply section 20, the communication path 21, and the cooling section 70 are not illustrated.

In the third embodiment, the molding machine 100c includes a first material extrusion mechanism 201 and a second material extrusion mechanism 202. The first material extrusion mechanism 201 and the second material extrusion mechanism 202 are disposed side by side in the X direction. The first material extrusion mechanism 201 and the second material extrusion mechanism 202 are disposed such that the heights in the vertical direction of the nozzle holes 92 respectively provided therein are equal. The first material extrusion mechanism 201 and the second material extrusion mechanism 202 are preferably disposed adjacent to each other. The first material extrusion mechanism 201 and the second material extrusion mechanism 202 only has to be disposed side by side in the horizontal direction without being limited to be disposed side by side in the X direction.

According to the third embodiment explained above, the molding machine 100c includes the two material extrusion mechanisms 200, and the two material extrusion mechanisms 200 are disposed side by side in the horizontal direction. For that reason, it is possible to discharge more plasticized material per unit time than when the molding machine 100c includes one material extrusion mechanism 200. Therefore, it is possible to improve the productivity of a molded product.

### D. Other Embodiments

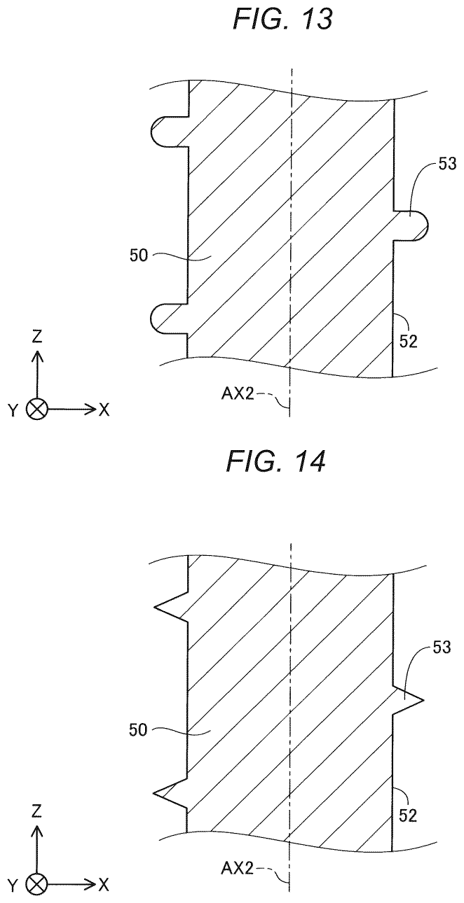

(D-1) In the embodiments explained above, the cross section of the flight section 53 in the first cross section has the rectangular shape having the first side 151 and the second side 152 parallel to the rotation axis AX2. In contrast, as illustrated in FIG. 13, in the cross section of the flight section 53 in the first cross section, the end portion on the radial direction side of the flight section 53 may have an arc shape. Here, the radial direction is a direction orthogonal to the rotation axis AX2 and is a direction away from the rotation axis AX2. As illustrated in FIG. 14, the cross section of the flight section 53 in the first cross section may have a triangular shape. According to the aspect explained above, it is possible to further reduce the likelihood of the material supplied from the supply port 44 being pinched between the screw 50 and the cylinder 40.
(D-2) In the embodiments explained above, the cylinder 40 includes the section to be cooled 42 cooled by the cooling section 70 and the section to be heated 43 located below the section to be cooled 42 and heated by the heating section 80. In contrast, the cylinder 40 may be formed of one member. That is, the cylinder 40 may not include the section to be cooled 42 and the section to be heated 43.
(D-3) In the embodiments explained above, the supply port 44 is provided at the connecting section of the section to be cooled 42 and the section to be heated 43. In contrast, the supply port 44 may be provided in the section to be cooled 42 and may not be provided in the section to be heated 43.
(D-4) In the embodiments explained above, the screw 50 includes, at the upper end portion, the third portion 130 in which the outer diameter of the screw 50 is the first diameter. In contrast, the screw 50 may not include the third portion 130.
(D-5) In the embodiments explained above, the width in the horizontal direction of the screw drive section 60 is larger than the width in the horizontal direction of the first cooling section 71. In contrast, the width in the horizontal direction of the screw drive section 60 may not be larger than the width in the horizontal direction of the first cooling section 71.
(D-6) In the embodiments explained above, the communication path 21 is coupled to the cylinder 40 from the obliquely upward direction. In contrast, the communication path 21 may be coupled to the cylinder 40 from a direction other than the obliquely upward direction.
(D-7) In the third embodiment, the molding machine 100c includes the two material extrusion mechanisms 200. In contrast, the molding machine 100c may include three or more material extrusion mechanisms 200. In this case, the three or more material extrusion mechanisms 200 are disposed side by side in the horizontal direction.
(D-8) The above disclosure may be implemented in the form of the material extrusion mechanism 200 rather than the molding machine 100.

### E. Other Aspects

The present disclosure is not limited to the embodiments explained above and can be implemented in various aspects without departing from the spirit of the present disclosure. For example, the present disclosure can also be implemented in following aspects. In order to solve a part or all of the problems of the present disclosure or in order to achieve a part or all of the effects of the present disclosure, technical features in the embodiments explained above corresponding to technical features in aspects described below can be replaced or combined as appropriate. The technical features can be deleted as appropriate unless being explained as essential features in the present specification.
(1) According to a first aspect of the present disclosure, a material extrusion mechanism is provided. The material extrusion mechanism includes: a cylinder including a supply port to which a material is supplied, the cylinder being provided in a vertical direction; a screw including a spiral flight section and configured to rotate centering on a rotation axis extending in the vertical direction on an inside of the cylinder; a first cooling section provided to surround a part of the screw; a heating section provided to surround a part of the screw below the first cooling section; and at least one nozzle configured to discharge the material plasticized on the inside of the cylinder, wherein at least a part of the supply port overlaps the first cooling section in a horizontal direction, the screw includes a first portion in which an outer diameter of the flight section is a first diameter and a second portion in which the outer diameter of the flight section is a second diameter smaller than the first diameter, the first portion overlaps the heating section in the horizontal direction, and the second portion overlaps the first cooling section in the horizontal direction.

According to the aspect explained above, in the material extrusion mechanism that plasticizes the material by the screw rotating centering on the rotation axis extending in the vertical direction, it is possible to reduce the likelihood of the material supplied from the supply port being pinched between the screw and the cylinder.
(2) In the aspect explained above, the cylinder may include: a section to be cooled by the first cooling section; and a section to be heated located below the section to be cooled and heated by the heating section, and the supply port may be located at a connecting section of the section to be cooled and the section to be heated.
(3) In the aspect explained above, the cylinder may include: a section to be cooled by the first cooling section; and a section to be heated located below the section to be cooled and heated by the heating section, the first cooling section may be a cooling flow path in which a coolant flows, and the cooling flow path may be provided above the section to be cooled and a region heated by the heating section in the section to be heated.

According to the aspect explained above, since the temperature gradient of the screw in the vertical direction can be increased, it is possible to reduce the likelihood of the material supplied from the supply port being pinched between the screw and the cylinder in the material extrusion mechanism in which the screw is short in the vertical direction.
(4) In the aspect explained above, the heating section may be an electric heater.
(5) In the aspect explained above, the material extrusion mechanism may further include a screw drive section provided above the screw and including a motor that rotates the screw, the screw may include a third portion in which an outer diameter is the first diameter, and the third portion may be located at an upper end portion of the screw.

According to the aspect explained above, it is possible to prevent the material supplied from the supply port into the cylinder from intruding into the screw drive section.
(6) In the aspect explained above, the material extrusion mechanism may further include a screw drive section provided above the screw and including a motor that rotates the screw, and the width in the horizontal direction of the screw drive section may be larger than the width in the horizontal direction of the first cooling section.

According to the aspect explained above, a motor having size enough for obtaining output necessary for the rotation of the screw can be installed in the screw drive section.
(7) In the aspect explained above, the material extrusion mechanism may further include a communication path that causes a material supply section in which the material is stored and the supply port to communicate, and the communication path may be coupled to the cylinder from an obliquely upward direction.
(8) In the aspect explained above, a cross section of the flight section in a cross section of the screw including the rotation axis may have a trapezoidal shape having a first side and a second side parallel to the rotation axis, the first side may be located at a position further away from the rotation axis than the second side, and the length of the first side may be equal to or smaller than the length of the second side, and the flight section may have a stepped shape at a boundary between the first portion and the second portion.

According to the aspect explained above, when the screw rotates centering on the rotation axis, it is possible to make it easy to convey the material downward.
(9) In the aspect explained above, in a cross section of the flight section in a cross section of the screw including the rotation axis, an end portion in a direction orthogonal to the rotation axis and on a radial direction side away from the rotation axis may have an arc shape, or the cross section of the flight section in the cross section of the screw including the rotation axis may have a triangular shape.

According to the aspect explained above, it is possible to reduce the likelihood of the material supplied from the supply port being pinched between the screw and the cylinder.
(10) In the aspect explained above, the at least one nozzle may be two or more nozzles.

According to the aspect explained above, it is possible to improve the productivity of the molded product compared with when the material extrusion mechanism includes one nozzle.
(11) According to a second aspect of the present disclosure, a molding machine is provided. The molding machine includes: at least one of the material extrusion mechanisms in the first aspect; a material stacking section on which the material discharged from the nozzle is stacked; and a moving mechanism configured to change relative positions of the material extrusion mechanism and the material stacking section, and the molding machine molds a molded product by stacking the material discharged from the nozzle.

According to the aspect explained above, since the temperature gradient of the screw in the vertical direction can be increased in the material extrusion mechanism provided in the molding machine, it is possible to reduce the likelihood of the material supplied from the supply port from being pinched between the screw and the cylinder in the material extrusion mechanism in which the screw is short in the vertical direction.
(12) In the aspect explained above, the molding machine may further include a machining section that machines the molded product.

According to the aspect explained above, it is possible to improve the quality of the molded product by the machining section adjusting the shape of the molded product.
(13) In the aspect explained above, the at least one material extrusion mechanism may be two or more material extrusion mechanisms, and the two or more material extrusion mechanisms may be disposed side by side in the horizontal direction.

According to the aspect explained above, it is possible to improve the productivity of the molded product compared with when the molding machine includes one material extrusion mechanism.

What is claimed is:

1. A material extrusion mechanism comprising:
a cylinder including a supply port to which a material is supplied, the cylinder being provided in a vertical direction;
a screw including a spiral flight section and configured to rotate centering on a rotation axis extending in the vertical direction on an inside of the cylinder;
a first cooling section provided to surround a part of the screw;
a heating section provided to surround a part of the screw below the first cooling section; and
at least one nozzle configured to discharge the material plasticized on the inside of the cylinder, wherein
at least a part of the supply port overlaps the first cooling section in a horizontal direction,
the screw includes:
a first portion in which an outer diameter of the flight section is a first diameter; and
a second portion in which the outer diameter of the flight section is a second diameter smaller than the first diameter,
the first portion overlaps the heating section in the horizontal direction, and
the second portion overlaps the first cooling section in the horizontal direction.

2. The material extrusion mechanism according to claim 1, wherein
the cylinder includes:
a section to be cooled by the first cooling section; and
a section to be heated located below the section to be cooled and heated by the heating section, and
the supply port is located at a connecting section of the section to be cooled and the section to be heated.

3. The material extrusion mechanism according to claim 1, wherein
the cylinder includes:
a section to be cooled by the first cooling section; and
a section to be heated located below the section to be cooled and heated by the heating section,
the first cooling section is a cooling flow path in which a coolant flows, and
the cooling flow path is provided above the section to be cooled and a region heated by the heating section in the section to be heated.

4. The material extrusion mechanism according to claim 1, wherein the heating section is an electric heater.

5. The material extrusion mechanism according to claim 1, further comprising a screw drive section provided above the screw and including a motor that rotates the screw, wherein
the screw includes a third portion in which an outer diameter is the first diameter, and
the third portion is located at an upper end portion of the screw.

6. The material extrusion mechanism according to claim 1, further comprising a screw drive section provided above the screw and including a motor that rotates the screw, wherein
the width in the horizontal direction of the screw drive section is larger than the width in the horizontal direction of the first cooling section.

7. The material extrusion mechanism according to claim 1, further comprising a communication path that causes a material supply section in which the material is stored and the supply port to communicate, wherein
the communication path is coupled to the cylinder from an obliquely upward direction.

8. The material extrusion mechanism according to claim 1, wherein a cross section of the flight section in a cross section of the screw including the rotation axis has a trapezoidal shape having a first side and a second side parallel to the rotation axis, the first side is located at a position further away from the rotation axis than the second side, and the length of the first side is equal to or smaller than the length of the second side, and
the flight section has a stepped shape at a boundary between the first portion and the second portion.

9. The material extrusion mechanism according to claim 1, wherein, in a cross section of the flight section in a cross section of the screw including the rotation axis, an end portion in a direction orthogonal to the rotation axis and on a radial direction side away from the rotation axis has an arc shape, or the cross section of the flight section in the cross section of the screw including the rotation axis has a triangular shape.

10. The material extrusion mechanism according to claim 1, wherein the at least one nozzle is two or more nozzles.

11. A molding machine comprising:
at least one of the material extrusion mechanisms according to claim 1;
a material stacking section on which the material discharged from the nozzle is stacked; and
a moving mechanism configured to change relative positions of the material extrusion mechanism and the material stacking section, wherein
the molding machine molds a molded product by stacking the material discharged from the nozzle.

12. The molding machine according to claim 11, further comprising a machining section configured to machine the molded product.

13. The molding machine according to claim 11, wherein
the at least one material extrusion mechanism is two or more material extrusion mechanisms, and
the two or more material extrusion mechanisms are disposed side by side in the horizontal direction.
